(19) United States
(12) Patent Application Publication
(10) Pub. No.: US 2021/0074109 A1
(43) Pub. Date: Mar. 11, 2021

(54) VERIFICATION OF AN ARTICLE PROVIDED WITH A SECURITY ELEMENT

(71) Applicant: GIESECKE+DEVRIENT CURRENCY TECHNOLOGY GMBH, München (DE)

(72) Inventors: Georg DEPTA, Rosenheim (DE); Tilo FRITZHANNS, Munchen (DE); Christian FUHSE, Otterfing (DE)

(21) Appl. No.: 16/074,858

(22) PCT Filed: Feb. 1, 2017
(86) PCT No.: PCT/EP2017/000125

§ 371 Date: Aug. 2, 2018

(30) Foreign Application Priority Data
Feb. 9, 2016 (DE) 10 2016 001 465.2

(51) Int. Cl. G07D 7/207; B42D 25/305; G07D 7/202; G06K 9/62

(52) U.S. Cl. CPC G07D 7/207; B42D 25/305; B42D 25/23; G06K 9/6202; G07D 7/205

(57) ABSTRACT

A method for verifying an object is furnished with a security element in which the security element is manufactured in a multi-step method with register variations and contains in a check field an individual characteristic feature of the security element in the form of a superimposition of at least two areal regions. The check field of the security element is optically captured by a camera, the area proportions of the superimposed and not superimposed areal regions are determined and from it a check value for the individual characteristic feature of security element is formed and compared with a reference check value, on which a verification result for the object furnished with the security element is created.

The invention relates to the verification of an object furnished with a security element and, in the process, concerns in particular a verification method and an appurtenant computer program product, a verification system for carrying out the method, a security element or a checking apparatus for such a verification system, and an object furnished with such a security element.

Data carriers, such as value documents or identification documents, but also other objects of value, such as branded articles, are often provided for protection with security elements which permit a check of the authenticity of the data carrier and which at the same time serve as protection from unauthorized reproduction.

For reliably checking the authenticity of such security elements, elaborate checking apparatuses are often used, for example in cash deposit machine or in bank-note processing machines in commercial banks. However, in many cases such complex apparatuses are not available, for example upon checking a security element “in the field” or a security element used for securing an extended or bulky object that cannot easily be placed in a checking apparatus together with the object. In the process, a one-hundred-percent authenticity check is often not at all required, it rather suffices to be able to recognize or exclude an imitation or a transfer of the security element to another object with high probability.

On these premises, the invention is based on the problem of stating method and appurtenant apparatuses by which an object furnished with a security element can be verified in a simple manner and nevertheless with high reliability. In particular, the verification should also be possible in the field with the help of a smartphone as a checking apparatus.

The invention contains for this purpose a method for verifying an object furnished with a security element in which the security element is manufactured in a multi-step method with register variations and contains in a check field an individual characteristic feature of the security element in the form of a superimposition of at least two areal regions, which are generated upon the manufacture of the security element in different manufacturing steps with register variations, wherein in the method
the check field of the security element is optically captured by a camera,
the area proportions of the superimposed and/or not superimposed areal regions are determined and from it a check value for the individual characteristic feature of the security element is formed,
the formed check value is compared with a reference check value, and
on the basis of the comparison result, a verification result for the object furnished with the security element is created.

In the process, the reference check value is advantageously formed upon or after the manufacture of the security element or upon or after the furnishing of the object with the security element, by determining the area proportions of the superimposed and/or not superimposed areal regions and forming therefrom the reference check value.

The reference check value can be stored in a database together with an individual marking of the security element and/or the object and be queried from the database for comparison with the formed check value.

Alternatively or additionally, the reference check value can be present in particular in encrypted or encoded form in the security element or in the object furnished with the security element and can be read in for comparison with the formed check value. A reference check value applied to the security element or object is advantageously applied by print plate-less methods, for instance in the form of a laser marking, by means of ink jet or toner-based methods. In this case, a depositing of the reference check value in a database can be dispensed with, so that an expensive database with short access times and a very large database can be dispensed with.

The code containing the reference check value can be developed proprietarily for this method or be based on standard procedures, such as Data Matrix or other 2D codes, wherein the data contained in the code is advantageously encrypted and/or signed. For encrypting and decrypting, standard methods can be used, asymmetric methods having public and private keys are advantageous, wherein also proprietary derivations of these methods can be employed, as long as the necessary security standards are adhered to.

Additionally, further checks can be performed prior to the comparison of check value and reference check value which confirm the employment of printing methods from the security print and thus exclude copies which are always based on pixelated scans. Advantageously, for this purpose the typically rather high resolution of smartphone cameras is utilized. Furthermore, a simple plausibility check can check whether the identical check field was already read in in unusual temporal or spatial intervals. Checks performed in the field can be recorded not only for this purpose and thus focal points with many forgeries be established. Upon use for bank notes, it is therefore made possible for a central bank, by an access to the check data, to simultaneously observe the circulation behavior of its notes and to conduct therefrom plan data which help to avoid unnecessarily high or too small volumes in the print and just as well for the stockpiling.

In an advantageous embodiment, the check field of the security element is optically captured with a smartphone camera and the determination of the area proportion and the forming of the check value is effected through a software program running on the smartphone, hereinafter also called app.

In order to have a great number of register variation combinations available, the verification method is advantageously carried out in a check field which contains a superimposition of three, four or more areal regions which are generated upon the manufacture of the security element in different manufacturing steps with register variations.

The verification method is advantageously carried out in a check field whose areal regions are generated at least partly by printing methods, in particular offset printing, indirect letterpress printing, intaglio printing, screen printing, letterpress, block print or flexographic printing. Likewise advantageously, the verification method is carried out in a check field whose areal regions are formed at least partly by applications, in particular applied foil elements, or by elements or windows on the applications. Further advantageously, the verification method is carried out in a check field whose areal regions are formed at least partly by planar laser cuttings, watermarks, laser markings, ink-jet inscriptions or toner-based methods. For printing inks, glazing inks are advantageous, totally covering inks, however, can also be used. The printing inks can have the same hue or different hues, so that mixed colors are produced in the superimposed areas.

With regard to the reachable resolution, the finest line on bank-note substrates in the background print (indirect letterpress printing) typically is positively 30 μm wide, negatively 50 μm, commonly 40 μm or 80 μm; the finest line on bank-note substrates in the offset printing typically is positively 25 μm wide, negatively 35 μm, commonly 30 μm or 50 μm; the finest line on bank-note substrates in intaglio printing positively 15 μm, negatively 10 μm, commonly 50 μm or 30 μm; the finest line in screen printing is positively 250 μm wide, negatively 500 μm, commonly 400 μm or 900 μm; and the finest line in block print (impression work with the numbering) is commonly 700 μm wide.

Using print plate-less methods, a variation of the distances of print elements in the check field can also be generated already in one printing cycle and thereby an additional information item be incorporated into the check field. For example, the distance of print elements or marking elements generated in a manufacturing step can be varied and the local distribution of the elements be deposited together with an individual marking, such as for instance a serial number, in a database.

Preferably, the verification method is carried out in a check field whose areal regions consist respectively of a multiplicity of small print elements, in particular in the form of characters or graphic elements. The small print elements in particular have a greatest extension of 3 mm or less, preferably of 2 mm or less.

To enable an especially reliable check value determination, the check field can have several partial regions in which the relative locations of the respective print elements are displaced relative to each other. In the process, first a partial check value can be formed for each partial region and then the partial check values can be summarized to an overall check value, for example by adding up, multiplying, dividing or correlating, or by a combination with other evaluation methods such as pattern recognition. The subdivision into partial regions can be performed, for example, in the form of fields, rows or columns.

Especially advantageously, the verification method is carried out in a security element which is integrated into the object. For example, the security element can be a part of a bank note or other value document. In this case, the check field is advantageously smaller than the object and occupies, for example for a value document, expediently at most half of the area of the value document. The check field is further advantageously arranged near a serial number, identification number or another code of the security element or object to be captured, to be able to easily capture both with the camera.

The invention also contains a verification system for carrying out the method of the above-described kind, having
an object furnished with a security element in which the security element is manufactured in a multi-step method with register variations and contains in a check field an individual characteristic feature of the security element in the form of a superimposition of at least two areal regions which are generated upon the manufacture of the security element in different manufacturing steps with register variations, and
a checking apparatus for the verification of the object, having
   a camera for the optical capture of the check field of the security element,
   an evaluation unit for determining the area proportions of the superimposed and/or not superimposed areal regions and for the forming of a check value for the individual characteristic feature of the security element from it, and
   means for comparing the formed check value with a reference check value and for creation of a verification result on the basis of the comparison result.

In the process, the checking apparatus advantageously contains means for capturing an encoded reference check value, for decoding the captured reference check value and for comparing the formed check value with the decoded reference check value.

In the process, the superimposed areal regions, in particular the size of the print elements of the areal regions, can be adapted to the requirements, for example the resolution of the checking apparatus.

In an advantageous development there is further provided that
the verification system comprises a database in which for the security elements are deposited respectively a reference check value together with an individual marking of the security element and/or the object, and that
the checking apparatus contains means for querying the reference check value or the comparison result of check value and reference check value from the database on the basis of the individual marking of the security element and/or the object.

In the process, the checking apparatus can in particular be a bank-note processing machine or a smartphone.

The invention also contains a security element for a verification system of the above-described kind that is manufactured in a multi-step method with register variations and contains in a check field an individual characteristic feature of the security element in the form of a superimposition of at least two areal regions, which are generated upon the manufacture of the security element in different manufacturing steps with register variations, as well as the employment of such a security element for verifying an object furnished with the security element. The invention further contains an object, in particular value document, security paper, identification card or branded article having such a security element.

The invention furthermore contains a checking apparatus for a verification system of the above-described kind having
a camera for the optical capture of the check field of the security element,
an evaluation unit for determining the area proportions of the superimposed and not superimposed areal regions and for forming a check value for the individual characteristic feature of the security element therefrom, and
means for comparing the formed check value with a reference check value and for creating a verification result on the basis of the comparison result.

The invention contains finally also a computer program product which has machine-readable program commands for a control unit of a data-processing apparatus, in particular a smartphone, which cause the latter to execute a method of the above-described kind.

In further variants of the invention, individual codes or markings of the security element which are integrated into the design of the check field can be used. These can serve, on the one hand, for recognizing the individual security element or the object and identifying for a database query, and can also ensure that even with rougher scanning, each individual security element remains distinguishable.

The individualization can consist in particular of characters, graphic elements, line or 2D codes or similar, and either be recognizable as those or be integrated into the design. Codes preferably have a redundancy of the useful contents or error correction elements. Preferably the individualization is part of the data which yield the above-mentioned check value.

For example, a numbering can superimpose the check field and thus contribute to the check value. Since, for example, for bank notes or other value documents, no serial number resembles any other, this contribution is always individual. If only a part of the numbering is superimposed, it is expedient due to the usual numbering schemes to employ the rear characters of a number, which change from note to note, in order to attain a good distinction between the sheets; and to employ in contrast the front characters in order to attain a good distinction between the individual copies within a sheet. The check value can be calculated either purely according to the above-mentioned methods, or be supplemented by an OCR reading of the numbering. For the numbering, for example, the letterpress numbering conventional in the bank-note printing can be used, but also print plate-less methods such as laser marking or ink jet method.

As a further example, ink, ink constituents or metallization can be removed from foil elements by a laser marking or a color impression can be generated. Accordingly, prints can be modified individually in the check field by changing color fields, by removing the ink, by removing the absorbent ink constituents or by removing metallizations from foil elements; however, a further color impression can also be added by blackening the substrate or a color switch. If for at least a portion of the prints an ink is used that absorbs the laser radiation, mixed forms of removing and adding may also occur.

In an especially advantageous embodiment of a laser marking, the laser is used only to remove ink or to lighten it individually for each security element. Although this can be visible in the check field recognizable to the user, it can, however, also extend over a greater region of the object furnished with the security element. These markings lie expediently in regions manufactured with different steps and have for each bank note an individual location whose coordinates or relative position toward each other likewise represents a check value. In the process, advantageously a foil application is additionally incorporated, thus for instance demetallized in some regions by the laser.

For a bank note, this check value can be assigned to the bank note identified by the serial number and an encrypted code can be applied to the bank note from the serial number, verification value and, if applicable, the signature of the issuing office, in particular again using a print plate-less process, for example the same laser marking unit. In the latter case, the code with its relative position can also belong to the check value. Advantageously, all data can, yet do not have be, stored in a database for later tracking of the note.

In the field, the check value can be determined and be read simultaneously with a public key from the code and compared. For this method, the register variations do not have to be surveyed upon printing and in the field, since solely the position of the markings to each other is of importance. A database query is also not absolutely necessary, but is nevertheless advantageous.

Upon the individualization, ink jet printers can primarily be used to print individual graphic elements or codes. In most cases they can only add ink, but also bleach out ink, where applicable, by solvents or other combinations of substances.

The security element or check field can contain, for example, also links to consumer information as they are supplied for instance via QR (Quick responses) codes, or Data Matrix Codes. Such codes can, but do not have to, be integrated into the design of the check field, but do not have to contribute to the check value.

For the evaluation of an optically captured check field, the image captured by the smartphone camera can first be preprocessed in a per se known manner, for example by transformations in position space or frequency domain, for instance by Fourier transformation or wavelet analysis, by projections, interpolations, for instance between different grids, resolutions or coordinate systems, scalings, rotations, filtering, isotropically as well as anisotropically, morphological methods, segmentation and methods of the feature extraction, pattern recognition, entropy measurement, or averaging.

For the improvement of the results, a one-time calibration of the employed camera of the checking apparatus can be required in field, for example, by a white balance or the recording of a test pattern. The evaluation can be facilitated by register markers which can also result from prominent places of the design, and thus improve the alignment and/or scaling of the image upon the preprocessing. Codes can advantageously also serve as register markers.

The evaluation can be facilitated and be improved in the field and, where applicable, also upon the manufacture, by the recording of several images, where applicable, from different angles and distances (called video mode hereinafter). In this case, the security features can also be verified in the check field which offer different impressions depending on the viewing angle.

The codes used within the framework of the invention can be visually recognizable as such and thereby excite for utilization, or can be integrated in the design of the check field and, where applicable, even be hidden. While hidden codes are constructed advantageously two-dimensionally, the recognizable codes advantageously are 1D codes, such as the bar codes EAN, 2/5i UPC, Code128, stacked 1D codes, such as PDF417, 2D codes, like QR codes or Data Matrix or mixed forms.

In the present case, 2D codes in particular are useful since the readout is advantageously effected with cameras, i.e. 2D sensors. However, utilizations with bar-code readers also come into consideration. The representation does not have to follow known standards, but can be proprietary as well. Thus it can be attained, for example, that the content can be read only by a certain app on a smartphone.

The content of the code(s) on a security element can contain an unambiguous signature of the issuing office. The content can contain authentic or pseudo random data. The content can also contain hashed check data for a later comparison. For a utilization with mobile devices, in particular a smartphone, the employment of asymmetric encryption methods in the process is advantageous.

Since, similar to biometrics, the actual measurands are of an analog nature, similar procedures are expedient for the storing upon the production and verification in the field: Thus, for example a “Fuzzy Vault” can be employed. For this purpose, additional error correction data (auxiliary data) can be applied to the security element or object, or be stored in a database, which provide for sufficient redundancy. In the process, the error correction and the elements to be read out are advantageously in a mutually closely coordinated manner. However, biometric standard methods with a once read-in template and the definition of maximally allowed deviations can be also used upon the measurement in the field.

Further, the so-called Biometric Template Protection can also be employed with which instead of the check data, protected reference data are stored which indeed allow a comparison, but no back computation to the original data. A Fuzzy Vault can again be employed for this purpose. However, the error tolerance can also often be attained by quantization of the analog input values.

To compare similar data and to determine the degree of the match, for example, the method of “context triggered piecewise hashes (CTPH)”, also known as “Fuzzy Hashing”, can be utilized. Also statistical methods such as “Principal Component Analysis (PCA)” can be employed for, or contribute to, storing and evaluating. Further, the code can contain not only the, where applicable, encrypted and signed check value, but also the possible range of variation. The variation can also be contained in a specially accordingly provided code. The variation can be encrypted and/or signed as well. Upon the verification, the range of variation can then be surveyed, also at another resolution, and be compared with the stated value. It can thus be established whether the check result lies within a precision established upon the first check as well as in the field. Depending on the resolution of the camera of the checking apparatus, the certainty of the verification thus increases. Further increased security arises from the simultaneous check of a signature.

The security element or check field can be combined with further security features, in particular with security features recognizable only by auxiliary means, as long as these do not impair the evaluation of the useful information item advantageously lying in the visible region of the light, or even contribute to this information item. In this way, the check field can serve to utilize the limited area, for example on bank notes, also for further security elements, and/or it can point out the actual function of the check field upon the check with the help of additional devices.

For example, a fluorescent print over the check field in the form of a smartphone or in the form of a QR code can point out that information items for smartphones are present when the note is held under a UV lamp, for instance at a cash register. Also, an IR split can be provided, for example in the check field, without impairing its function.

Effect colors can, due to their register variation over the other printing methods, contribute to information in the check field on the one hand and, on the other hand, allow checking without auxiliary means, for example, by means of color-shift effects. If a code is checked from several directions, for instance the color-shift effect can be checked also with the smartphone. This can happen, for example, by use of the above-described video mode upon the recording the check field.

Inks, threads or foils with magnetically hard or magnetically soft pigments or vapor depositions can also contribute to the machine readability without disturbing the principle of the check field. The same holds for inks which show piezochromic, photochromic or thermochromic effects which can also be excited electrically.

In the field, the described check of the check field can be combined with further procedures which allow a verification of the authenticity of the bank note. These include for example a check of the employed printing methods, a check of security features like holograms or effect inks as to angular-dependent correct image data or color data, a check of the interaction of printing ink and substrate in high-resolution recordings; a plausibility check with regard to the query times and query locations of the same serial number, or a check for presence of the serial number in a database of bank notes in circulation. Such supplementary procedures can be used in a simple way to rule out counterfeits of impression in advance.

As checking units there can also be considered, besides smartphones, in particular also stationary devices at bank note-processing plants, stationary devices at points of sale and teller machines which collect bank notes, specifically also at commercial banks, as well as mobile devices, specifically for checking the check fields for law enforcement authorities, points of sale, or offices and further government agencies.

Further embodiment examples as well as advantages of the invention will be explained hereinafter with reference to the figures, in whose representation a rendition that is true to scale and to proportion has been dispensed with in order to increase the clearness.

There are shown:

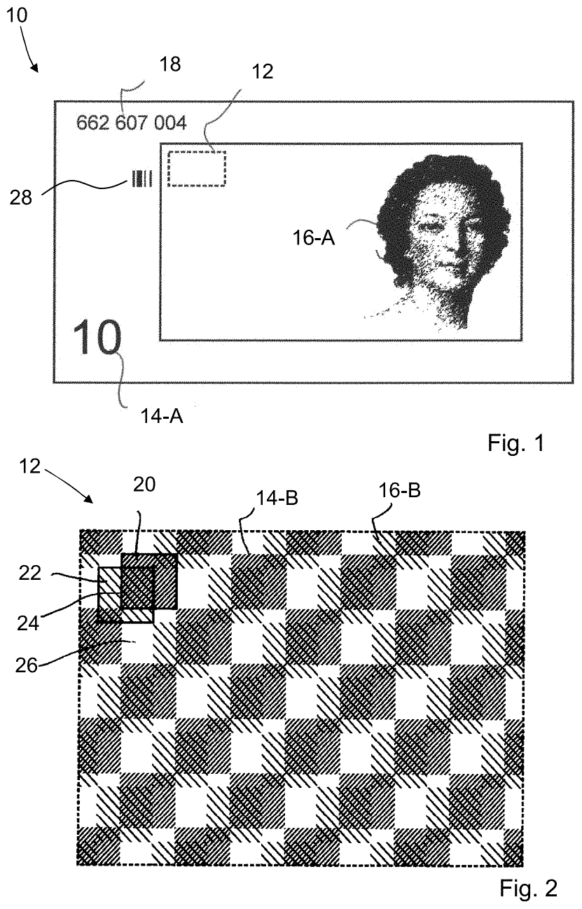

FIG. 1 in schematic representation, a bank note having a security element in the form of a check field printed on the bank note,

FIG. 2 a detail view of the check field of FIG. 1,

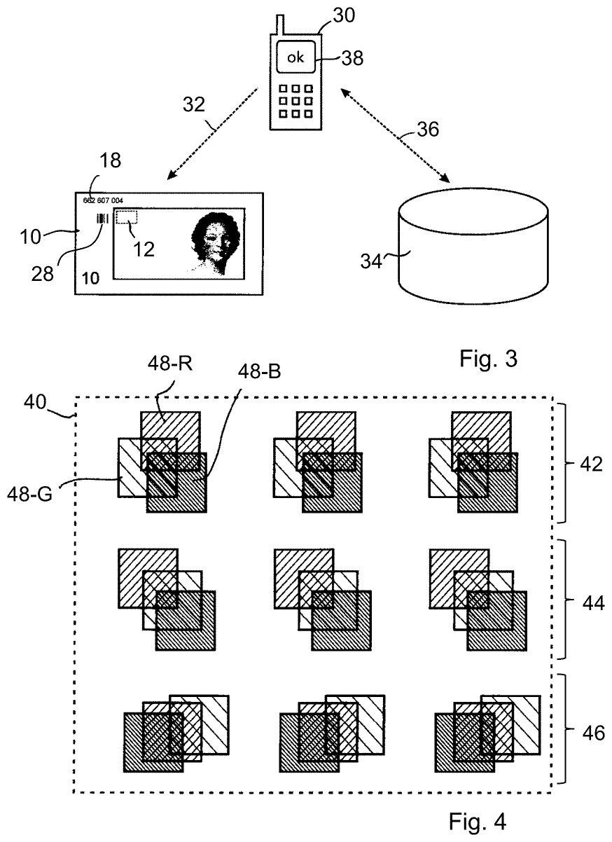

FIG. 3 a schematic representation of the components involved in the verification of the bank note of FIG. 1,

FIG. 4 a check field consisting of several partial regions having print elements displaced relative to each other,

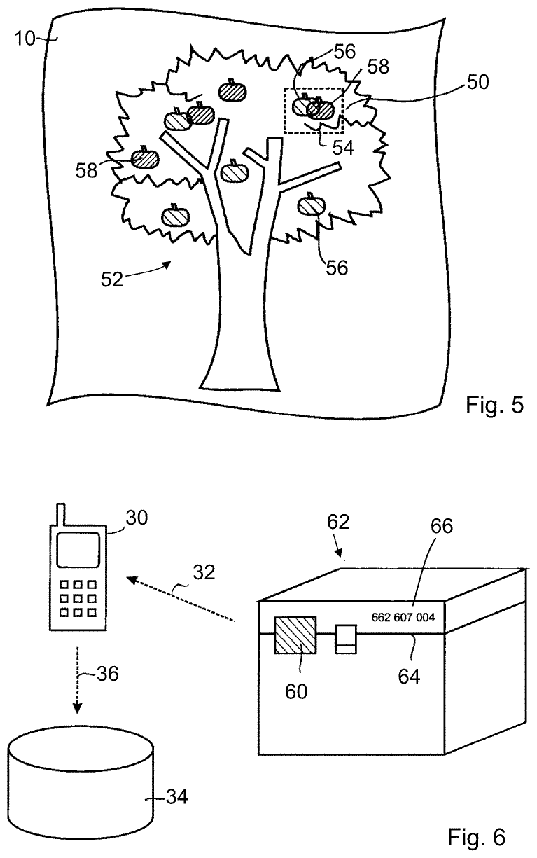

FIG. 5 a check field integrated in the graphic design of a bank note, and

FIG. 6 a design in which a check field is present in a separate security element which is applied onto a cashbox to be secured.

The invention will now first be explained by the example of the verification of a bank note with the help of a smartphone. FIG. 1 shows for this purpose a schematic representation of a bank note 10 having a security element in the form of check field 12 imprinted on the bank note 10. The check field 12 shown in detail in FIG. 2 is part of the bank note 10 and was generated together with the other print elements on the bank-note substrate upon the manufacture of the bank note 10. In other designs, the check field can, however, also be present on a separate security element, for example a transfer element, which is applied to a bank note or other object to be secured.

For checking the authenticity, the bank note 10 having the check field 12 can simply be captured optically in the hereinafter described manner with a smartphone camera and verified with the help of a check app installed on the smartphone.

In the process, the bank note 10 and the check field 12 are generated in a multi-step method with register variations. For example, the denomination number 14-A was applied to the bank note 10 in the screen printing method, a portrait 16-A in the intaglio printing method, and a serial number 18 in letterpress. Simultaneously with the denomination number 14-A, a first checkered pattern 14-B (in FIG. 2 tight hatching) was generated in the check field 12 by screen printing, as shown more precisely in the detail representation of the check field 12 in FIG. 2. In a separate printing step, a second checkered patterns 16-B (in FIG. 2 wide hatching) in the intaglio printing was generated in the check field 12 simultaneously with the portrait 16-A. Because of the generation of the elements 14-A/14-B or 16-A/16-B in respectively separate operations with different manufacturing methods, the unavoidable register variations occur in the process which lead to an offset of the two checkered patterns 14-B, 16-B in the check field 12.

The present inventors have now recognized that these unavoidable register variations of the different manufacturing processes can serve as a kind of fingerprint for the identification of a certain security element or a certain bank note.

For estimating, one can assume, for example, that the manufacturing steps involved in the generation of the check field 12 have respectively register variations of ±1 mm in mutually orthogonal directions (hereinafter designated as x and y direction). The maximally allowed variation amounts to, for example, ±1.5 mm. A typical smartphone camera with nominally 6 megapixels has a resolution of 2848×2136 pixels.

When, using such a camera, an area is recorded which contains at least the check field 12 and the serial number 18, for example, with a receiving area of 120 mm×90 mm, a point density of about 600 dpi or a resolution of 42 μm results. In two manufacturing steps there therefore result in every direction 2000 μm/40 μm=50 distinguishable locations, thus altogether 50²=2,500 different combinations of register variations. If three manufacturing steps are rendered in the check field 12, already 6,250,000 possibilities result.

If an areal region is present, for example in a security thread whose insertion location can vary in transverse direction by ±3 mm, thus the number of the possibilities can again be multiplied by 6000 μm/40 μm=150. For a security thread having a well recognizable subject, the location can also be employed in the longitudinal direction and thus further increase the number of the possible combinations.

With reference to FIG. 2 the register variations of the manufacturing steps screen printing (elements 14-A, 14-B) and intaglio printing (elements 16-A, 16-B) lead to an offset of both checkered patterns 14-B, 16-B which can be quantified, for example, by the area proportions of the superimposed and not superimposed areal regions 20, 22, 24, 26. As is recognizable in FIG. 2, there arise first areal regions 20 from the offset of the two checkered patterns 14-B, 16-B, in which only the printing ink of the screen printing step 14-B is present, second areal regions 22 in which only the printing ink of the intaglio printing step 16-B is present, third areal regions 24 in which the printing ink of the screen printing step and the printing ink of the intaglio printing step superimpose, and fourth areal regions 26 in which neither of the two printing inks are present. The relative area proportions of the areal regions 20 to 26 depend on concretely on the register variations occurred upon the manufacture of the bank note 10, hence from these a check value can be derived which represents a measure individual and characteristic for the bank note 10.

As is evident from the above estimate, the number of possible register variation combinations at the current resolution of smartphone cameras for two production steps is usually still too low to be able to make a clear identification of a bank note. Nevertheless, the number of the possibilities is already so large that in spite of the simple check with a smartphone, upon a positive verification an authentic bank note can be inferred with high probability. If a greater number of manufacturing steps is included, the number of register variation combinations can also be sufficient for an unambiguous identification of a bank note.

The check value derived from the relative area proportions can be captured upon or immediately after the manufacture of the bank note 10, for example upon the quality control of the bank notes, for the first time and be deposited together with the serial number 18 of the bank note 10 as a reference check value in a database 34 (FIG. 3). In the database 34, the serial number 18 is then linked to a certain relative area proportion of the areal regions 20-26 in the check field 12 of the bank note 10. As explained above, in the process the assignment does not necessarily have to be unambiguous for meaningful verification.

For the verification, the bank note 10 is then photographed, as shown in FIG. 3, by a user with the camera of his or her smartphone 30 (reference sign 32), and thereby the check field 12 and the serial number 18 optically captured. A check app running on the smartphone 30 can, on the one hand, read out the serial number 18 of the bank note 10 via an OCR module and, on the other hand, determine the area proportions 20-26 in the check field 12 via an image-processing module and therefrom form the check value for bank note 10.

The check app then sets up a connection 36 from the smartphone 30 to the database 34 and transfers the serial number 18 and the formed check value. In the database 34, the transferred check value is compared with the reference check value stored there for the serial number 18 and the comparison result is transferred back to the check app via the connection 36. This displays the result of the authenticity check, for example, in the display 38 and can give, for reinforcement, also an acoustic feedback about the successful or failed verification. In a variant, the database can also transfer the stored reference check value to the check app and the comparison of the formed check value with the reference check value can be performed in the check app itself.

Alternatively or additionally, the reference check value can, after its first-time capture, also be applied in encrypted form to the bank note 10, for example in the form of a bar code 28 arranged beside the check field 12. For verification, the bank note 10 can then be photographed by a user with the camera of his or her smartphone 30 and thereby the check field 12 be optically captured together with the bar code 28. The check app executed on the smartphone 30 then establishes via the image-processing module the area proportions 20-26 in the check field 12, forms therefrom the check value for bank note 10, reads the bar code 28 and decrypts the reference check value encoded thereby. The established check value is compared with the decrypted reference check value and the result of the authenticity check is displayed in the display 38 and is outputted, where applicable, also acoustically.

For the sake of simpler representation, a superimposition of only two areal regions is shown in FIG. 2, it will, however, be appreciated that in practice also a superimposition of three, four or more areal regions is possible and also often expedient because of the greater number of combination possibilities. Correspondingly, there are more possibilities of combination for the area overlaps than those stated in FIG. 2.

For the determination of the check value, the image captured by the camera of the smartphone is advantageously preprocessed in the above-described manner. Then, for example, a histogram can be formed in which the pixel frequencies of different colors or gray levels are determined. Further threshold values can be formed in different gradations or different color channels and the obtained pixel numbers again be determined, similar to a histogram. Further statistical methods of image processing which correlate different fields, for example via correlations with each other, can be also applied.

As shown in FIG. 4, a check field 40 can also consist of several partial regions 42, 44, 46, wherein the relative locations of the print elements 48-R, 48-G, 48-B of the individual print processes are displaced in the different partial regions relative to each other to make a particularly good evaluation of the area proportions of the superimposed and not superimposed areal regions possible. For example, it can be difficult to exactly determine the relative area proportions if the register variation of two areal regions of a bank note lies near zero, since hardly any non-superimposed areal regions then exist.

To remedy this, in one or several partial regions the print elements 48-R, 48-G, 48-B are arranged offset relative to each other such that with perfect register they do not cover each other completely. This is illustrated in FIG. 4 by the example of print elements which represent three basic color pixels 48-R, 48-G, 48-B of an RGB print. In each of the partial regions 42, 44, 46, three basic color pixels 48-R, 48-G, 48-B are arranged in a different relative location to each other, so that the register variations of three color channels in each partial region 42, 44, 46 affect the superimposed and not superimposed area proportions of the print elements differently and thus make the determination of the individual characteristic check value for the check field 40 more reliable. For example, a partial check value can be formed for each partial region 42, 44, 46 and the partial check values can be summarized by adding up or multiplying to an overall check value.

A check field does not have be present on the document as a separate field, it can also be integrated into the graphic design of the document, as is illustrated with the help of check field 50 of FIG. 5. In the shown embodiment example, a bank note 10 contains in a partial region a graphic 52 in the form of a tree applied in intaglio printing having apples of different color, namely having green apples generated in the simultaneous printing 56 and having red apples generated in the block print 58. The check field 50 contains a green apple 56, a red apple 58 and a part 54 of the leaf structure of the tree. Since all three print elements were manufactured in different prints using different manufacturing methods, they have individual characteristic register variations which can be captured in the check field 50 in the above-described manner with the help of a smartphone camera 30 and be compared with a reference check value.

In the process, the user does not need to know the presence or the position of check field 50 in graphic design 52. It suffices when the user records the entire bank note or at least the design 52 with his or her smartphone camera 30, because the check app knows the position of the check field 50 and its properties to be checked. Should the recording quality be insufficient or the check field 50 be recorded incompletely, the check app can generate an error message and request a renewed recording, where applicable, with an indication of the region to be recorded.

FIG. 6 shows a further embodiment example in which a check field of the above-described kind is present in a separate security element 60 which is applied to an object to be secured, such as a cashbox 62. The cashboxes 62 shown in the embodiment example in FIG. 6 is filled, closed and the cover gap 64 is sealed with the security element 60. Then the check field of the security element 60 is photographed, for example with the camera of a smartphone 30 (reference sign 32) and a check value for the security element 60 is established by an app in the above-described manner. Further, an identification number 66 of the cashbox 62 is either inputted or likewise captured with the camera. The app then sets up a connection 36 to a database 34 and transfers the identification number 66 and the formed check value for the security element 60 employed for safeguarding. The transferred check value is then deposited in the database 34 as a reference check value for the identification number 66 and thereby the security element 60 is linked with the cashbox 62 to be secured.

After the transport of the cashbox 62, the receiver can first check whether the security element 60 is intact and then verify that the security element 60 actually belongs to the identification number 66 of the cashbox 62. For this purpose, he or she merely has to photograph the check field of the security element 60 with the camera of his or her smartphone and input the identification number 66 of the cashbox 62 or likewise photograph it. The app then forms the check value for the security element 60, establishes, where applicable, the identification number 66 via an OCR module, then sets up a connection to the database 34 and transfers the identification number 66 and the formed check value. In the database 34, the transferred check value is compared with the reference check value stored there as to the identification number 66 and the comparison result is transferred back to the smartphone app which communicates the success or failure of the verification to the receiver.

### LIST OF REFERENCE SIGNS

10 Bank note
12 Check field
14-A Denomination number
14-B First checkered pattern
16-A Portrait
16-B Second checkered pattern
18 Serial number
20, 22, 24, 26 Areal regions
28 Bar code
30 Smartphone
32 Photographic capture
34 Database
36 Connection
40 Check field
42, 44, 46 Partial regions
48-R, 48-G, 48-B Print elements
50 Check field
52 Graphic
54 Part of the leaf structure
56 Green apples
58 Red apples
60 Security element
62 Cash box
64 Cover gap
66 Identification number

1.-20. (canceled)

21. A method for verifying an object furnished with a security element in which the security element is manufactured in a multi-step method with register variations and contains in a check field an individual characteristic feature of the security element in the form of a superimposition of at least two areal regions, which are generated upon the manufacture of the security element in different manufacturing steps with register variations, wherein in the method
the check field of the security element is optically captured by a camera,
the area proportions of the superimposed and/or not superimposed areal regions are determined and from it a check value for the individual characteristic feature of the security element is formed,
the formed check value is compared with a reference check value, and
on the basis of the comparison result, a verification result for the object furnished with the security element is created.

22. The method according to claim 21, wherein the reference check value is formed upon or after the manufacture of the security element, or upon or after the furnishing of the object with the security element, by determining the area proportions of the superimposed and/or not superimposed areal regions and forming therefrom the reference check value.

23. The method according to claim 21, wherein the reference check value is stored in a database together with an individual marking of the security element and/or the object and is queried from the database for comparison with the formed check value.

24. The methods according to claim 21, wherein the reference check value is present in particular in encrypted or encoded form in the security element or in the object furnished with the security element and is read in for comparison with the formed check value.

25. The method according to claim 21, wherein the check field of the security element is optically captured by a smartphone camera and the determination of the area proportion and the forming of the check value is effected through a software program running on the smartphone.

26. The method according to claim 21, wherein the verification method is carried out in a check field, which contains a superimposition of three, four or more areal regions, which are generated upon the manufacture of the security element in different manufacturing steps with register variations.

27. The method according to claim 21, wherein the verification method is carried out in a check field whose areal regions are generated at least partly by printing methods.

28. The method according to claim 21, wherein the verification method is carried out in a check field whose areal regions are formed at least partly by applications, or by elements or windows on the applications.

29. The method according to claim 21, wherein the verification method is carried out in a check field whose areal regions are formed at least partly by planar laser cuttings, watermarks, laser markings, ink-jet inscriptions or toner-based methods.

30. The method according to claim 21, wherein the verification method is carried out in a check field whose areal regions consist respectively of a multiplicity of small print elements.

31. The method according to claim 30, wherein the check field has several partial regions in which the relative locations of the respective print elements are displaced relative to each other.

32. The method according to claim 21, wherein the verification method is carried out in a security element which is integrated in the object.

33. A verification system for the carrying out of the method according to claim 21, having
an object furnished with a security element in which the security element is manufactured in a multi-step method with register variations and contains in a check field an individual characteristic feature of the security element in the form of a superimposition of at least two areal regions, which are generated upon the manufacture of the security element in different manufacturing steps with register variations and
a checking apparatus for the verification of the object, having
a camera for the optical capture of the check field of the security element,
an evaluation unit for determining the area proportions of the superimposed and not superimposed areal regions and for forming a check value for the individual characteristic feature of the security element therefrom, and
means for comparing the formed check value with a reference check value and for creation of a verification result on the basis of the comparison result.

34. The verification system according to claim 33, wherein the checking apparatus contains means for capturing an encoded reference check value, for decoding the captured reference check value and for comparing the formed check value with the decoded reference check value.

35. The verification system according to claim 33, wherein
the verification system comprises a database, in which are deposited for the security elements respectively a reference check value together with an individual marking of the security element and/or the object, and that
the checking apparatus contains means for querying the reference check value or the comparison result of check value and reference check value from the database on the basis of the individual marking of the security element and/or the object.

36. The verification system according to claim 33, wherein the checking apparatus is a bank-note processing machine or a smartphone.

37. Security element for a verification system according to claim 33 which is manufactured in a multi-step method with register variations and contains in a check field an individual characteristic feature of the security element in the form of a superimposition of at least two areal regions which are generated upon the manufacture of the security element in different manufacturing steps with register variations.

38. An object, in particular value document, security paper, identification card or branded article having a security element according to claim 37.

39. A checking apparatus for a verification system according to claim 33, having
a camera for the optical capture of the check field of the security element,
an evaluation unit for determining the area proportions of the superimposed and not superimposed areal regions and for forming a check value for the individual characteristic feature of the security element therefrom, and
means for comparing the formed check value with a reference check value and for creating a verification result on the basis of the comparison result.

40. A computer program product which has machine-readable program commands for a control unit of a data-processing apparatus which cause the latter to execute a method according to claim 21.
